(19) United States
(12) Patent Application Publication
(10) Pub. No.: US 2013/0171967 A1
(43) Pub. Date: Jul. 4, 2013

(54) Providing Secure Execution of Mobile Device Workflows

(71) Applicants: Ayman S. Ashour, Lincoln, NH (US); Philip Libin, San Jose, CA (US); Joseph Tassone, Bedford, MA (US)

(72) Inventors: Ayman S. Ashour, Lincoln, NH (US); Philip Libin, San Jose, CA (US); Joseph Tassone, Bedford, MA (US)

(21) Appl. No.: 13/343,261

(22) Filed: Jan. 4, 2012

(51) Int. Cl. H04W 12/00; H04W 12/06

(52) U.S. Cl. 455/411; 455/410

(57) ABSTRACT

Methods and apparatuses, including computer program products, are described for providing secure execution of mobile device workflows. A mobile device receives a request to launch a function on the mobile device. The mobile device displays a keypad associated with the launched function, the keypad having randomly-arranged alphanumeric characters. The mobile device receives entry of a passcode via the keypad and activates a short-range frequency interface on the mobile device upon validation of the entered passcode. The mobile device establishes a communication link with a second device using the short-range frequency interface, and executes a workflow based on data transmitted between the mobile device and the second device via the communication link.

### FIELD OF THE INVENTION

The subject matter of this application relates generally to methods and apparatuses, including computer program products, for providing secure execution of mobile device workflows.

### BACKGROUND OF THE INVENTION

As personal mobile devices have become increasingly common, manufacturers and developers have included an array of features to enable use of the devices beyond the typical telephone, messaging, web browsing and application functionality. One area of recent growth has been the use of mobile devices for information gathering and workflow management. For example, many devices are now equipped with short-range communications interfaces, such as Bluetooth, infrared and Near Field Communications (NFC), to enable interaction with a host of additional devices—including physical and logical access control devices, and point-of-purchase and/or electronic wallet devices.

Generally, mobile devices have not included technology which would protect the privacy of the user or prevent unauthorized use of the devices in the context of access control, point-of-purchase, or other interaction functions. However, more traditional hardware devices such as physical keypads and proximity card readers have security elements that would be useful in the context of mobile devices. One example of such security elements is a scrambled keypad 100 (or scramble pad), as shown in FIG. 1. Another example of a scrambled keypad is shown in U.S. Pat. No. 4,479,112, and a scrambled keypad plus proximity reader is shown in U.S. Pat. No. 6,102,286, both assigned to Hirsch Electronics Corp. The keypad 100 includes an array of buttons 110, some with alphanumeric characters (e.g., numbers 0-9), and a display 120 to confirm entry of a code. While the numbers on a standard keypad are arranged in sequentially-ordered rows starting from the left corner, a scramble pad generates a random arrangement of the numbers each time a person interacts with the keypad (as shown in FIG. 1). Using this technique, a potential intruder who attempts to glean the user's passcode or PIN by only seeing the location of the keys pressed will not be able to re-enter the code to gain unauthorized access. In addition, many security facilities are equipped with proximity card readers that use certain short-range frequencies (e.g., RFID) to read access cards that contain authentication data, and allow access based on the reader's verification of the authentication data.

### SUMMARY OF THE INVENTION

What is needed is a mobile device with a scramble keypad and a short-range frequency interface to communicate with another device to enable execution of workflows on the mobile device, including workflows that allow secure physical and logical access control, as well as process secure transactions using the mobile device.

The invention, in one aspect, features a method for providing secure execution of mobile device workflows. The method includes receiving, by a mobile device, a request to launch a function on the mobile device. The method also includes displaying, by the mobile device, a keypad associated with the launched function, the keypad having randomly-arranged alphanumeric characters, and receiving, by the mobile device, entry of a passcode via the keypad. The method also includes activating, by the mobile device, a short-range frequency interface on the mobile device upon validation of the entered passcode, and establishing, by the mobile device, a communication link with a second device using the short-range frequency interface. The method also includes executing, by the mobile device, a workflow based on data transmitted between the mobile device and the second device via the communication link.

The invention, in another aspect, features a system for providing secure execution of mobile device workflows. The system includes a mobile device configured to receive a request to launch a function on the mobile device, and display a keypad associated with the launched function, the keypad having randomly-arranged alphanumeric characters. The mobile device is also configured to receive entry of a passcode via the keypad, and activate a short-range frequency interface on the mobile device upon validation of the entered passcode. The mobile device is also configured to establish a communication link with a second device using the short-range frequency interface, and execute a workflow based on data transmitted between the mobile device and the second device via the communication link.

The invention, in another aspect, features a computer program product, tangibly embodied in a non-transitory computer-readable storage device, for providing secure execution of mobile device workflows. The computer program product includes instructions operable to cause a mobile device to receive a request to launch a function on the mobile device, and display a keypad associated with the launched function, the keypad having randomly-arranged alphanumeric characters. The computer program product also includes instructions operable to cause a mobile device to receive entry of a passcode via the keypad, and activate a short-range frequency interface on the mobile device upon validation of the entered passcode. The computer program product also includes instructions operable to cause a mobile device to establish a communication link with a second device using the short-range frequency interface, and execute a workflow based on data transmitted between the mobile device and the second device via the communication link.

In some embodiments, any of the above aspects can include one or more of the following features. In some embodiments, the second device includes a data-encoded tag, a smart card, a short-range frequency reader device, or another mobile device. In some embodiments, the short-range frequency includes RFID, NFC, or Bluetooth. In some embodiments, the communication link includes card emulation or peer-to-peer communication link capability.

In some embodiments, executing a workflow includes receiving, by the mobile device from the second device, a request for authentication data, transmitting, by the mobile device to the second device, authentication data including the entered passcode, and providing, by the second device, access to a secure area upon validation of the authentication data. In some embodiments, executing a workflow includes transmitting, by the mobile device to the second device, authentication data including the entered passcode, unlocking, by the second device, secure data stored on the second device upon validation of the authentication data, and receiving, by the mobile device from the second device, the secure data.

In some embodiments, executing a workflow includes transmitting, by the mobile device to the second device, authentication data including the entered passcode, and exchanging, between the mobile device and the second device, shared content upon validation of the authentication data. In some embodiments, executing a workflow includes broadcasting, by the mobile device, a connection request including the entered passcode, detecting, by the mobile device, additional devices in proximity to the mobile device by receiving responses to the connection request, and establishing a communication link between the mobile device and one or more of the additional devices upon validation of the authentication data.

In some embodiments, executing a workflow includes enabling, by the mobile device, access to an application installed on the mobile device upon validation of the entered passcode.

In some embodiments, executing a workflow includes automatically transmitting, by the mobile device, a message upon validation of the entered passcode.

In some embodiments, executing a workflow includes transmitting, by the mobile device, a request for content to a server, and receiving, by the mobile device, the requested content from the server. In some embodiments, the requested content includes audio content, video content, web browser content, or any combination thereof.

In some embodiments, executing a workflow includes reading, by the mobile device, a barcode based on instructions received from the second device. In some embodiments, executing a workflow includes transmitting, by the mobile device to the second device, authentication data including the entered passcode and payment processing data, executing, by the second device, a purchase transaction based on the payment processing data and upon validation of the authentication data, and receiving, by the mobile device from the second device, confirmation of the executed purchase transaction.

In some embodiments, activating a short-range frequency interface includes detecting, by the mobile device, a short-range frequency card in proximity to the mobile device, reading, by the mobile device, data from the short-range frequency card, and maintaining, by the mobile device, activation of the short-range frequency interface upon validation of the data read from the short-range frequency card. In some embodiments, the short-range frequency interface on the mobile device includes a card emulator configured to enable the mobile device to communicate with a card reader device.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a diagram of scramble keypad.

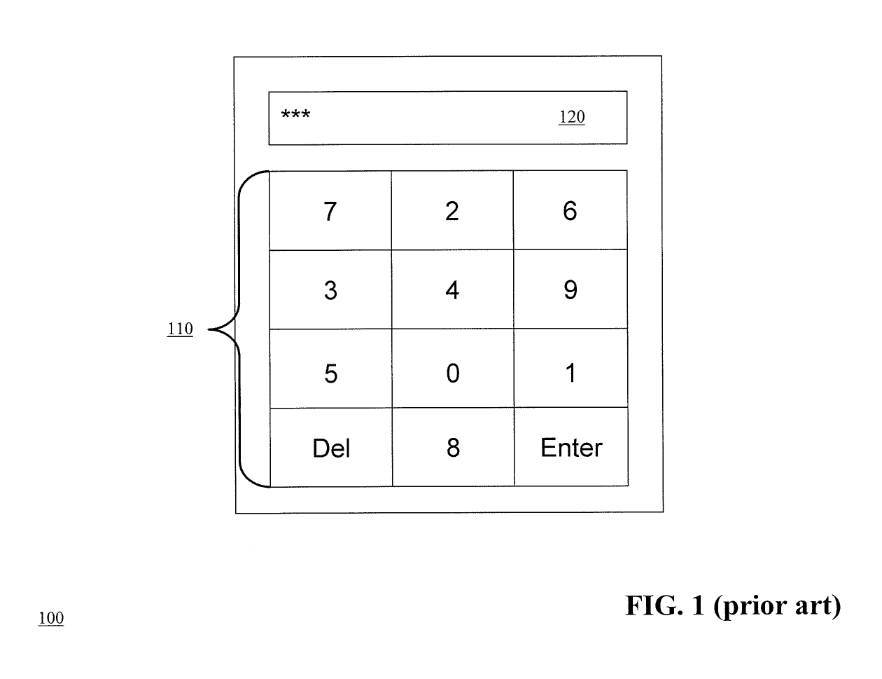

FIG. 2 is a block diagram of a system for providing secure execution of mobile device workflows.

FIG. 3 is a flow diagram of a method for providing secure execution of mobile device workflows.

FIG. 4 is a flow diagram of a process for executing a workflow using a mobile device to provide access to a secure area.

FIG. 5 is a flow diagram of a process for executing a workflow using a mobile device to provide access to secure data.

FIG. 6 is a flow diagram of a process for executing a workflow using a mobile device to exchange shared content with a second device.

FIG. 7 is a flow diagram of a process for executing a workflow using a mobile device to discover additional devices in proximity to the mobile device.

FIG. 8 is a flow diagram of a process for executing a workflow using a mobile device to enable access to an application installed on the mobile device and automatically transmit a message.

FIG. 9 is a flow diagram of a process for executing a workflow using a mobile device to request content from a server.

FIG. 10 is a flow diagram of a process for executing a workflow using a mobile device to conduct a point-of-purchase transaction.

### DETAILED DESCRIPTION

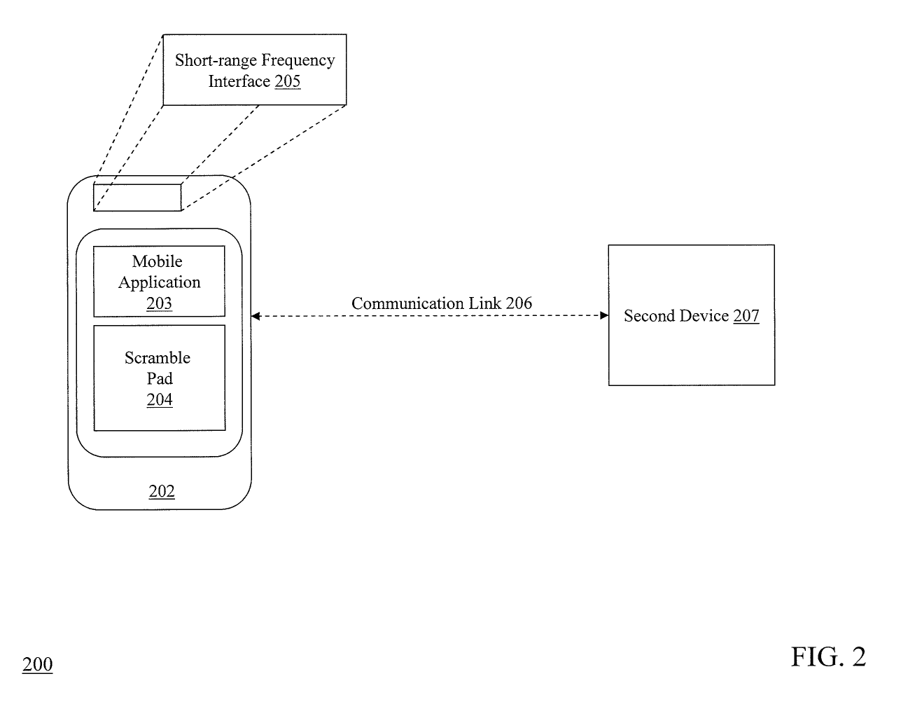

FIG. 2 is a block diagram of a system 200 for providing secure execution of mobile device workflows. The system 200 includes a mobile computing device 202 having one or more mobile applications (e.g., 203), a scramble pad 204, and a short-range frequency interface 205. The system 200 also includes a communications link 206 and a second device 207. Although FIG. 2 depicts only a single mobile computing device 202, a single communications link 206, and a single second device 207, the techniques described herein are not limited to this structure. Instead, this system 200 can include any of a number of configurations or components (e.g., multiple mobile computing devices, multiple links, and multiple second devices) that do not depart from the scope and spirit of the invention.

The mobile computing device 202 communicates with the second device 207 via the communications link 206. Example mobile computing devices 202 can include, but are not limited to a smart phone (e.g., Apple iPhone®, BlackBerry®, Android™-based device) or other mobile communications device, a tablet computer, an internet appliance, a personal computer, or the like. In some examples, the mobile device 202 can be installed in a vehicle. The mobile device 202 can be configured to include an embedded digital camera apparatus, and a storage module (e.g., flash memory) to hold photographs, video or other information captured with the camera. The mobile device 202 includes network-interface components to enable the user to connect to a communications network, such as the Internet, wireless network (e.g., GPRS, CDMA), or the like. The mobile device 202 includes a processor and operating system to allow execution of mobile applications (e.g., 203), including a scramble pad 204, and a screen for displaying the applications to a user. The mobile device 202 includes a short-range frequency interface 205 that enables the mobile device 202 to communicate with other devices (e.g., second device 207) that are in proximity to the mobile device 202 via communications link 206.

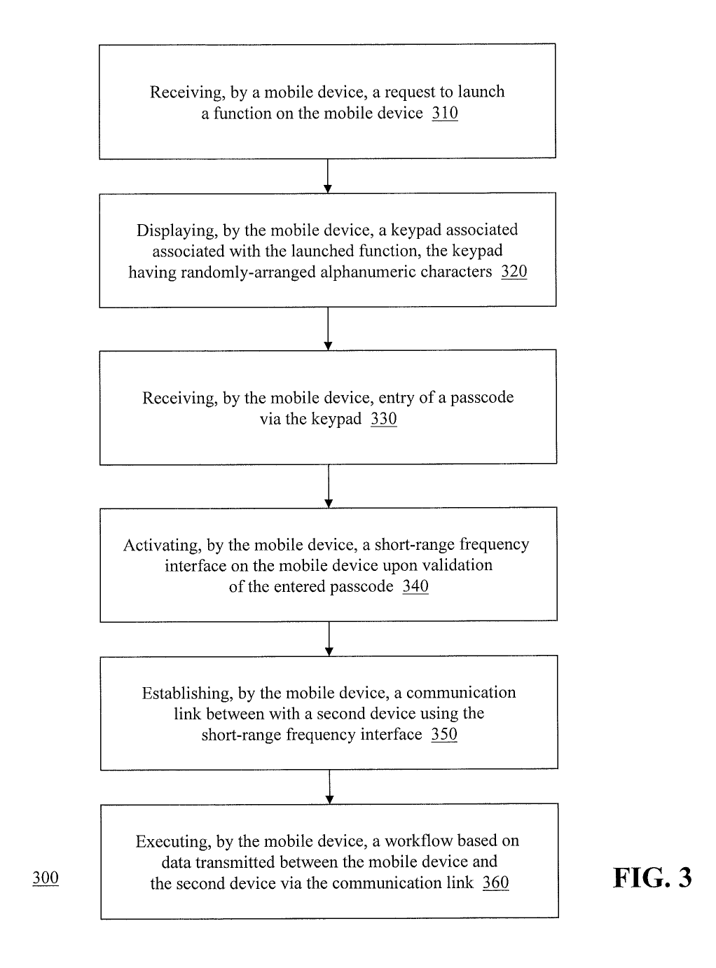

FIG. 3 is a flow diagram of a method 300 for providing secure execution of mobile device workflows, using the system 200 of FIG. 2. The mobile device 202 receives (310) a request to launch a function or application (e.g., mobile application 203) installed on the mobile device. For example, a user can tap or click an icon or function key associated with the application 203 that is displayed on the screen of the mobile device 202. Upon receiving the request, the mobile device 202 displays (320) a keypad 204 associated with the launched function. The keypad can be another application that is installed on the mobile device 202. The keypad 204 has the feature of a scramble pad where the alphanumeric characters on each of the keys of the keypad are arranged in a randomly-generated pattern. For example, the number ‘1’ on a standard keypad is located in the upper-left corner, while the number ‘1’ on a scramble pad can be located in any of the possible key locations. The mobile device 202 receives (330) entry of a passcode via the scramble pad 204. An advantage of using a scramble pad to authorize launching of a function is the additional security the scramble pad provides, as a user presses a sequence of keys in different locations each time the passcode is entered. Additionally, a person attempting to steal the passcode by viewing the location of keys pressed is unable to replicate the passcode because the location of keys changes from one entry attempt to the next entry attempt.

The passcode entered by the user can be context-specific. For example, entry of a first passcode can enable certain functionality associated with the launched function or application, while entry of a second passcode can enable other functionality. For a shared mobile device, different passcodes can be used to indicate the identity of the user currently accessing the mobile device.

Upon validation of the entered passcode, the mobile device 202 activates (340) a short-range frequency interface 205 located on the mobile device 202. In some embodiments, the short-range frequency interface 205 can include a radio-frequency identification (RFID) interface, an NFC interface, and/or a Bluetooth interface. The short-range frequency interface 205 can comprise a combination of hardware (e.g., an RF receiver, antenna) and software to manage the interface 205. The short-range frequency interface 205 interacts with other devices (e.g., second device 207) in proximity to the mobile device 202 that have the capability to communicate with the mobile device 202 via a communication link 206 using short-range frequency. Examples of second devices 207 include data-encoded tags, smart cards, proximity access cards, short-range frequency reader devices, and mobile devices (e.g., smartphones, PDAs, tablets).

In some embodiments, the mobile device 202 can be used in conjunction with a smart card or other short-range frequency card to enhance the security provided to the mobile device 202. For example, the short-range frequency interface 205 of the mobile device 202 detects a short-range frequency card in proximity to the device 202 The short-range frequency interface 205 reads data from the short-range frequency card and, upon validation of the data from the card, the mobile device 202 maintains the activation of the short-range frequency interface 205. In cases where the data from the short-range frequency card cannot be validated, the mobile device 202 is configured to deactivate the short-range frequency interface 205, thus preventing further use of the interface 205 without the required card. In some embodiments, the mobile device 202 can also lock itself or become deactivated if data from the short-range frequency card is unavailable or cannot be verified.

The short-range frequency interface 205 can include a card emulator configured to enable the mobile device 202 to communicate with a card reader device (e.g., second device 207). In this manner, the mobile device 202 can act as a replacement for a smartcard carried by the user, such that the mobile device 202 is used to access the same types of devices and information as the smartcard.

The short-range frequency interface 205 on the mobile device 202 is used to further enhance the security features of the mobile device. As will be described in greater detail below, the mobile device uses the short-range frequency interface 205 to communicate with another device (e.g., second device 207) by establishing (350) a communication link 206. In some embodiments, the communication link 206 between the mobile device 202 and the second device 207 is a peer-to-peer link. Once the communication link has been established, the mobile device 202 executes (360) a workflow based on data transmitted between the mobile device and the second device 207 via the communication link. The workflow can comprise a number of different tasks and/or process steps that are related to security, such as physical access control, logical access control, data access, content sharing, discovering other devices, execution of applications, or transmission of alerts or other messages.

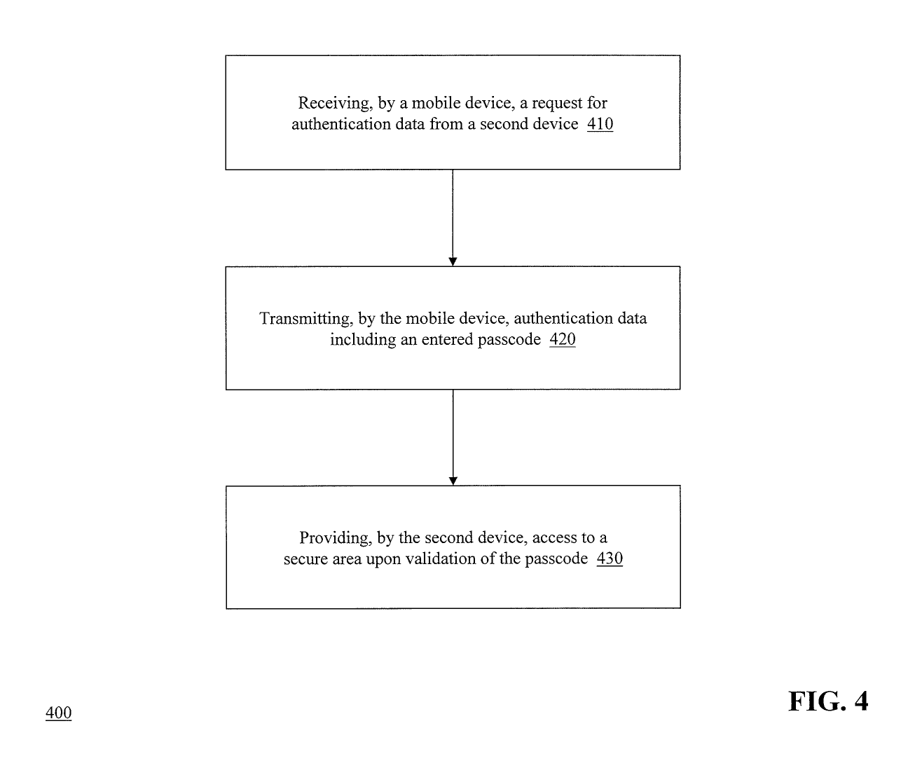

FIG. 4 is a flow diagram of a process 400 for executing a workflow using a mobile device to provide access to a secure area using the system 200 of FIG. 2. An example of this type of workflow is when a user needs to unlock a door or gate that is connected to a short-range frequency reader. The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. In some embodiments, the mobile device 202 stores the passcode in a local storage memory, in an encrypted format. In some embodiments, the mobile device 202 communicates with a remote device (e.g., a security server) via a wireless network (e.g., cellular, satellite, wireless access point) to retrieve an encrypted passcode. During validation, the mobile device compares the entered passcode with the encrypted passcode. If the passcodes match, validation is successful. If the passcodes do not match, validation is unsuccessful and the mobile device 202 does not proceed further.

Upon successful validation, the mobile device 202 activates the short-range frequency interface 205 and establishes a link with a second device. In the example shown in FIG. 4, the mobile device 202 uses the short-range frequency interface 205 to communicate with a reader device (e.g., a smartcard reader) connected to a door or gate and controlling the locking mechanism of the door or gate. The mobile device receives (410) a request for authentication data from the reader device. For example, the reader device detects the mobile device 202 as being in close proximity to the reader and requests data from the mobile device 202 in order to verify the identity of the user. The mobile device 202 transmits (420) the authentication data to the reader device. The authentication data can include the passcode entered by the user on the scramble pad 204. The authentication data can also include other security data stored on the mobile device, such as an encryption token or key. Upon receiving the authentication data, the reader device validates the data by, for example, comparing the data against the user's data stored in a pre-established security database to determine whether the user is allowed access to the area behind the door or gate. If the reader device confirms that the user is entitled to pass through the door or gate, the reader device provides (430) access to the secure area by unlocking the door.

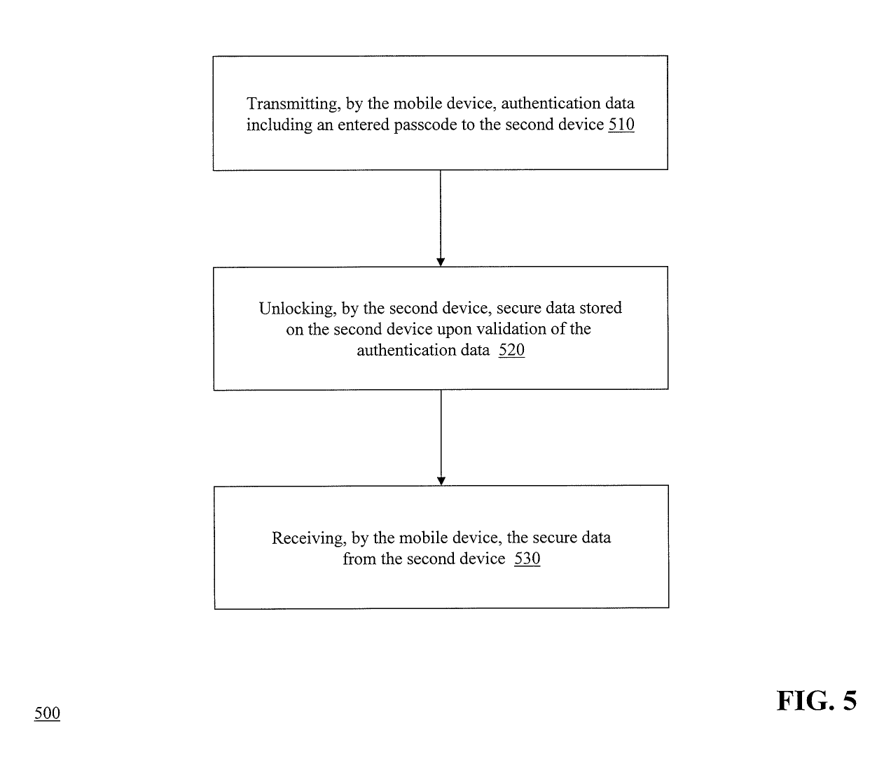

FIG. 5 is a flow diagram of a process 500 for executing a workflow using a mobile device to provide access to secure data using the system 200 of FIG. 2. An example of this type of workflow is when a user needs to access data that is stored on another device (e.g., a data-encoded tag, a mobile device). The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. During validation, the mobile device compares the entered passcode with the encrypted passcode. If the passcodes match, validation is successful. If the passcodes do not match, validation is unsuccessful and the mobile device 202 does not proceed further.

Upon successful validation, the mobile device 202 activates the short-range frequency interface 205 and establishes a link with a second device. In the example shown in FIG. 5, the mobile device 202 uses the short-range frequency interface 205 to communicate with a second device 207 (e.g., a data-encoded tag) that has secure data stored. The mobile device 202 transmits (510) authentication data including the entered passcode to the data-encoded tag 207 (or other device) via the communication link 206. The data-encoded tag 207 unlocks (520) secure data that is stored on the tag 207 upon validating the authentication data. In some embodiments, the previous validation that occurred on the mobile device 202 results in the second device 207 eliminating the step of validating the authentication data independently. After unlocking the data (e.g., providing access to the data, decrypting or otherwise), the second device 207 transmits the data to the mobile device 202.

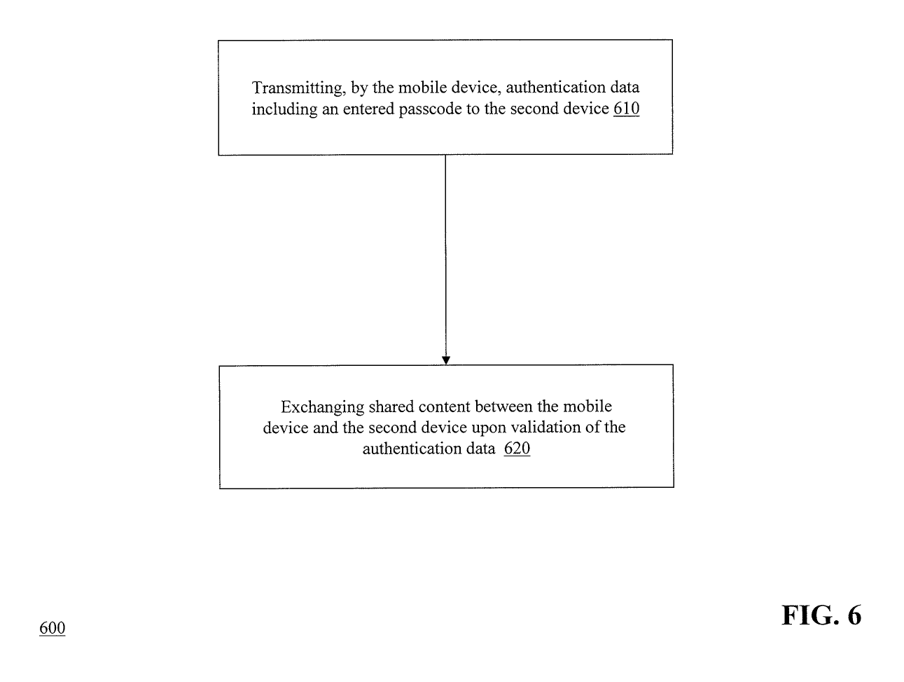

FIG. 6 is a flow diagram of a process 600 for executing a workflow using a mobile device to exchange shared content with a second device, using the system 200 of FIG. 2. An example of this type of workflow is when a user of mobile device 202 would like to exchange content (e.g., music, video, games) with another mobile device (e.g., second device 207). The two devices 202, 207 create an ad-hoc or temporary connection for the purpose of exchanging content. The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. During validation, the mobile device compares the entered passcode with the encrypted passcode. If the passcodes match, validation is successful. If the passcodes do not match, validation is unsuccessful and the mobile device 202 does not proceed further.

Upon successful validation, the mobile device 202 activates the short-range frequency interface 205 and establishes a link with a second device 207. In the example shown in FIG. 6, the mobile device 202 uses the short-range frequency interface 205 to communicate with a second device 207 (e.g., another mobile device). Either of the devices 202, 207 or both can have content to be exchanged with the other device. The mobile device 202 transmits (610) authentication data including the entered passcode to the second device 207 via the communication link 206. The second device 207 validates the authentication data and exchanges (620) shared content with the mobile device 202. In some embodiments, the second device 207 also transmits authentication data to the mobile device 202 to initiate a reciprocal authentication procedure, such that each device 202, 207 successfully authenticates to the other device—creating a more secure connection between the devices. The shared content exchanged between the devices 202, 207 can be audiovisual content, such as song files, video clips, and game applications. The shared content can also comprise the playing of a game where each device 202, 207 initiates its own game application and the devices exchange data that results in moves or other game play being displayed on each device 202, 207 in synchronization with each other.

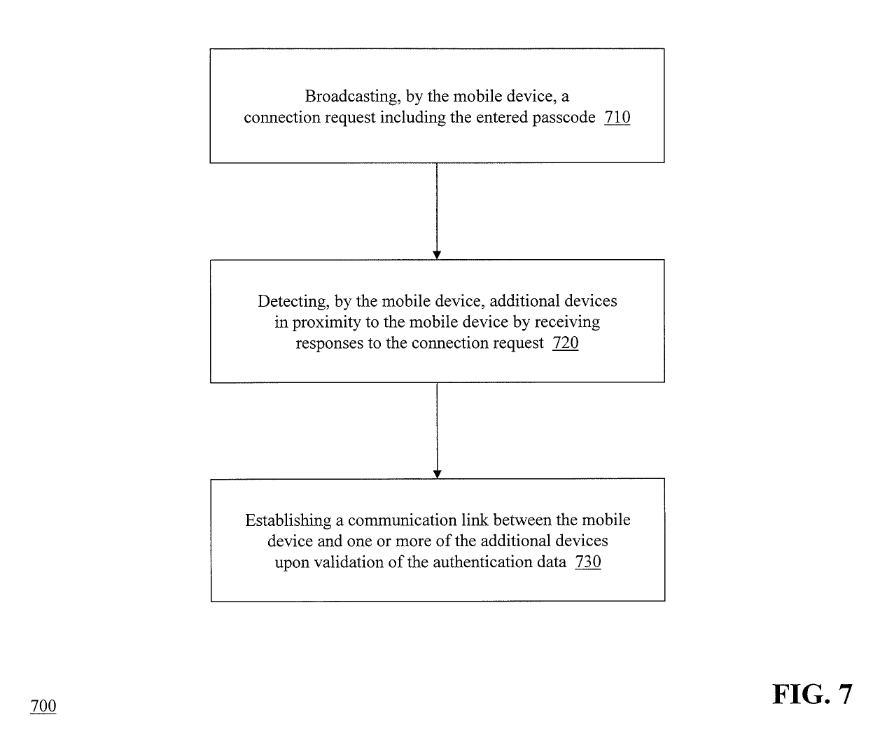

FIG. 7 is a flow diagram of a process 700 for executing a workflow using a mobile device to discover additional devices in proximity to the mobile device, using the system 200 of FIG. 2. An example of this type of workflow is when a user of mobile device 202 would like to determine if other devices capable of short-range communication with the mobile device 202 are nearby. This technique is useful when the user is not yet aware of any other devices nearby, or when there are a multitude of other users with mobile devices in a limited area, and the user wants to understand how many devices are capable of communicating with the mobile device 202. The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. During validation, the mobile device compares the entered passcode with the encrypted passcode. If the passcodes match, validation is successful. If the passcodes do not match, validation is unsuccessful and the mobile device 202 does not proceed further.

Upon successful validation, the mobile device 202 activates the short-range frequency interface 205 and establishes a link with a second device 207. In the example shown in FIG. 7, the mobile device 202 uses the short-range frequency interface 205 to broadcast (710) a connection request including the entered passcode in a radius around the mobile device 202. The broadcast radius can be dependent on the capability of the short-range frequency interface 205 equipped in the mobile device 202. The mobile device 202 detects (720) additional devices in proximity to the mobile device 202 by receiving responses to the connection request from the additional devices. The mobile device 202 establishes (730) a communication link with one or more of the additional devices upon validation of the authentication data.

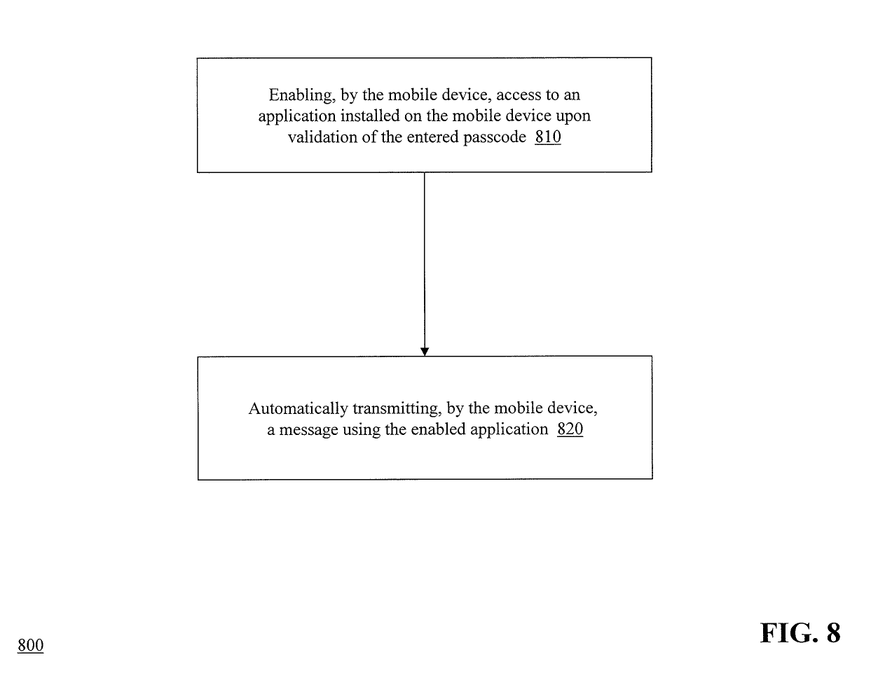

FIG. 8 is a flow diagram of a process 800 for executing a workflow using a mobile device to enable access to an application installed on the mobile device and automatically transmit a message, using the system 200 of FIG. 2. An example of this type of workflow is when a user of mobile device 202 needs to send an alert message automatically without requiring manual entry of information. The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. During validation, the mobile device compares the entered passcode with the encrypted passcode. If the passcodes match, validation is successful. If the passcodes do not match, validation is unsuccessful and the mobile device 202 does not proceed further.

In the example shown in FIG. 8, upon successful validation, the mobile device 202 enables (810) access to an application installed on the mobile device 202. The application can be, for example, an email application, a text messaging application, or an emergency application. The mobile device 202 automatically transmits (820) a message using the accessed application. One example use case for this workflow is transmission of an emergency alert when the user is in danger or is unable to use the phone normally. Entry of a passcode results in the immediate and automatic transmittal of an alert (e.g., distress or panic message) to an appropriate authority for response.

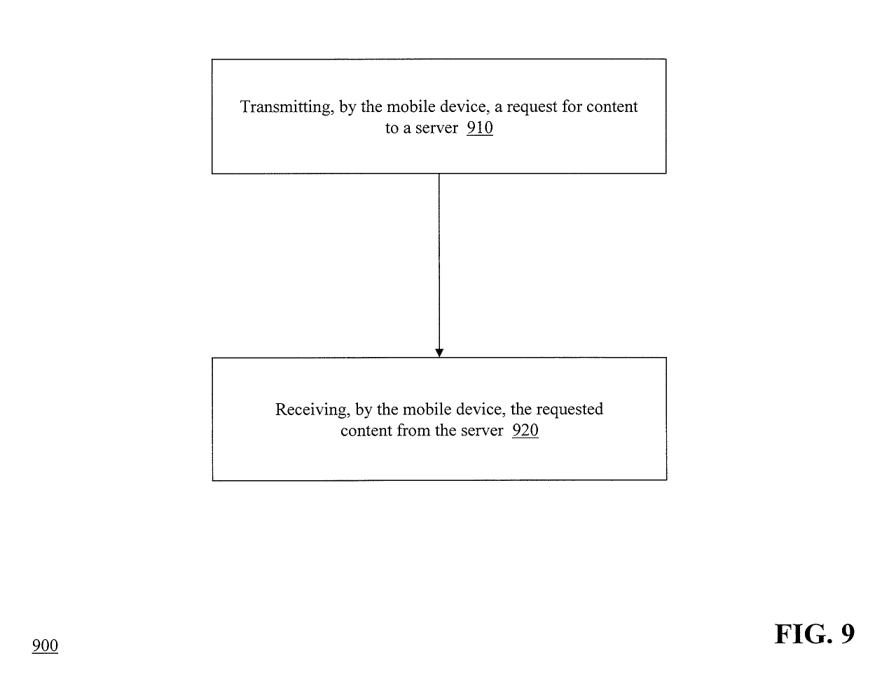

FIG. 9 is a flow diagram of a process 900 for executing a workflow using a mobile device to request content from a server, using the system 200 of FIG. 2. An example of this type of workflow is when a user of mobile device 202 communicates with a second device 207 to receive additional information or content from a remote server associated with the second device 207. This technique is useful, for example, in the context of an advertisement for a product or a service where the mobile device 202 can interact with a second device 207 (e.g., a data-encoded tag) affixed to a product, which launches a browser window on the mobile device 202 that provides the user with additional information on the product. The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. During validation, the mobile device compares the entered passcode with the encrypted passcode. If the passcodes match, validation is successful. If the passcodes do not match, validation is unsuccessful and the mobile device 202 does not proceed further.

Upon successful validation, the mobile device 202 activates the short-range frequency interface 205 and establishes a link with a second device 207. In the example shown in FIG. 9, the mobile device 202 uses the short-range frequency interface 205 to receive content information (e.g., a URL to a product website) from the second device 207. The mobile device 202 uses the content information to transmit (910) a request for content to a server identified in the content information. The mobile device 202 receives (920) the requested content from the server and displays the content to the user. For example, if the content information includes a URL to a product website, the mobile device 202 can use an installed web browser to navigate to the server identified in the URL. The mobile device 202 can then receive a web page or other content from the server in response to the request.

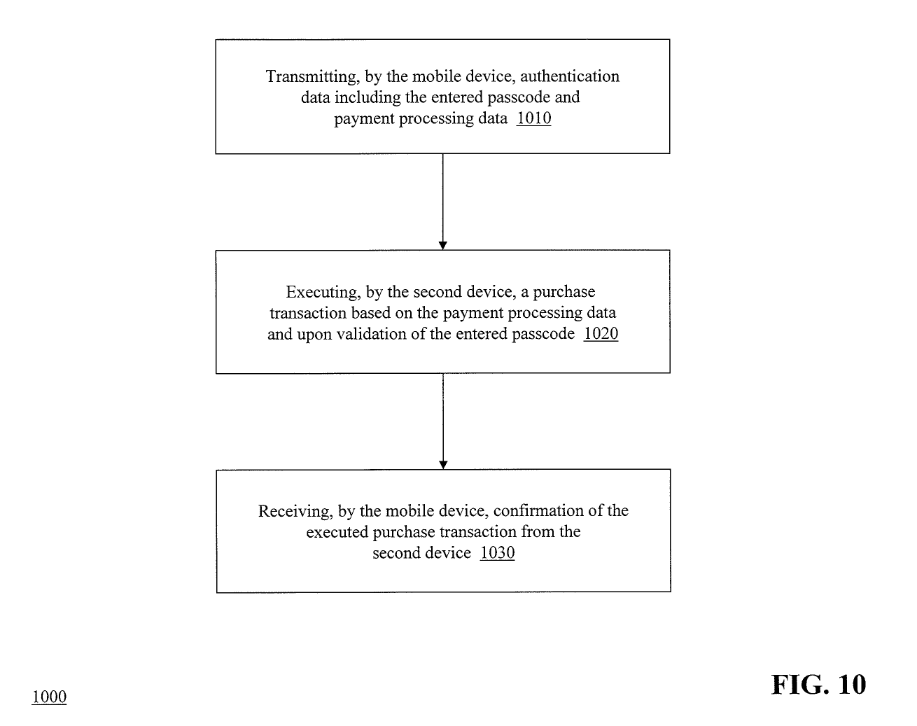

FIG. 10 is a flow diagram of a process 1000 for executing a workflow using a mobile device to conduct a point-of-purchase transaction, using the system 200 of FIG. 2. An example of this type of workflow is when a user of mobile device 202 conducts a purchase transaction using payment information stored on the mobile device 202. The user launches a security function or application (e.g., application 203) on the mobile device 202 and is presented with a scramble pad (e.g., scramble pad 204) on the touchscreen of the mobile device 202. The user enters his or her passcode using the scramble pad, and the mobile device 202 validates the entered passcode. During validation, the mobile device compares the entered passcode with the encrypted passcode. If the passcodes match, validation is successful. If the passcodes do not match, validation is unsuccessful and the mobile device 202 does not proceed further.

Upon successful validation, the mobile device 202 activates the short-range frequency interface 205 and establishes a link with a second device 207 (e.g., a cash register or payment processing terminal). In the example shown in FIG. 10, the mobile device 202 uses the short-range frequency interface 205 to transmit (1010) authentication data including the entered passcode and payment processing data to the second device 207. The payment processing data can include credit card information, debit card information, bank account information, routing information, account balance, e-wallet information, and other similar types of payment data. Upon receiving the payment processing data and validating the authentication data, the second device 207 executes (1020) a purchase transaction based on the payment processing data. After the transaction is executed, the mobile device 202 receives (1030) confirmation of the executed purchase transaction from the second device 207 via the communication link 206. The confirmation can include a receipt, a notification that the transaction is complete, or other similar information.

Another example of a workflow executable by the mobile device 202 is the reading of a barcode based on instructions received from the second device 207. For example, once the communication link 206 is established between the mobile device 202 and the second device 207, the mobile device can receive an instruction from the second device 207 to read a barcode or other type of data-encoded tag. This technique is useful in the context of remote workflow management, where mobile users are required to perform certain tasks (e.g., inventory, surveys) involving the reading and recordation of data from encoded tags or barcodes.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A method for providing secure execution of mobile device workflows, the method comprising:
receiving, by a mobile device, a request to launch a function on the mobile device;
displaying, by the mobile device, a keypad associated with the launched function, the keypad having randomly-arranged alphanumeric characters;
receiving, by the mobile device, entry of a passcode via the keypad;
activating, by the mobile device, a short-range frequency interface on the mobile device upon validation of the entered passcode;
establishing, by the mobile device, a communication link with a second device using the short-range frequency interface; and
executing, by the mobile device, a workflow based on data transmitted between the mobile device and the second device via the communication link.

2. The method of claim 1, wherein the second device includes a data-encoded tag, a short-range frequency reader device, or another mobile device.

3. The method of claim 1, wherein the short-range frequency includes RFID, NFC, or Bluetooth.

4. The method of claim 1, wherein the communication link includes card emulation or peer-to-peer communication link capability.

5. The method of claim 1, wherein executing a workflow includes:
receiving, by the mobile device from the second device, a request for authentication data;
transmitting, by the mobile device to the second device, authentication data including the entered passcode; and
providing, by the second device, access to a secure area upon validation of the authentication data.

6. The method of claim 1, wherein executing a workflow includes:
transmitting, by the mobile device to the second device, authentication data including the entered passcode;
unlocking, by the second device, secure data stored on the second device upon validation of the authentication data; and
receiving, by the mobile device from the second device, the secure data.

7. The method of claim 1, wherein executing a workflow includes:
transmitting, by the mobile device to the second device, authentication data including the entered passcode; and
exchanging, between the mobile device and the second device, shared content upon validation of the authentication data.

8. The method of claim 1, wherein executing a workflow includes:
broadcasting, by the mobile device, a connection request including the entered passcode;
detecting, by the mobile device, additional devices in proximity to the mobile device by receiving responses to the connection request; and
establishing communication links between the mobile device and one or more of the additional devices upon validation of the authentication data.

9. The method of claim 1, wherein executing a workflow includes:
enabling, by the mobile device, access to an application installed on the mobile device upon validation of the entered passcode.

10. The method of claim 1, wherein executing a workflow includes:
automatically transmitting, by the mobile device, a message upon validation of the entered passcode.

11. The method of claim 1, wherein executing a workflow includes:
transmitting, by the mobile device, a request for content to a server; and
receiving, by the mobile device, the requested content from the server.

12. The method of claim 11, wherein the requested content includes audio content, video content, web browser content, or any combination thereof.

13. The method of claim 1, wherein executing a workflow includes:
reading, by the mobile device, a barcode based on instructions received from the second device.

14. The method of claim 1, wherein executing a workflow includes:
transmitting, by the mobile device to the second device, authentication data including the entered passcode and payment processing data;
executing, by the second device, a purchase transaction based on the payment processing data and upon validation of the authentication data; and
receiving, by the mobile device from the second device, confirmation of the executed purchase transaction.

15. The method of claim 1, activating a short-range frequency interface includes:
detecting, by the mobile device, a short-range frequency card in proximity to the mobile device;
reading, by the mobile device, data from the short-range frequency card; and
maintaining, by the mobile device, activation of the short-range frequency interface upon validation of the data read from the short-range frequency card.

16. The method of claim 1, wherein the short-range frequency interface on the mobile device includes a card emulator configured to enable the mobile device to communicate with a card reader device.

17. A system for providing secure execution of mobile device workflows, the system comprising:
a mobile device configured to:
receive a request to launch a function on the mobile device;
display a keypad associated with the launched function, the keypad having randomly-arranged alphanumeric characters;
receive entry of a passcode via the keypad;
activate a short-range frequency interface on the mobile device upon validation of the entered passcode;
establish a communication link with a second device using the short-range frequency interface; and
execute a workflow based on data transmitted between the mobile device and the second device via the communication link.

18. The system of claim 17, wherein the second device includes a data-encoded tag, a short-range frequency reader device, or another mobile device.

19. The system of claim 17, wherein the short-range frequency includes RFID, NFC, or Bluetooth.

20. The system of claim 17, wherein the communication link includes card emulation or peer-to-peer communication link capability.

21. The system of claim 17, wherein executing a workflow includes:
receiving, by the mobile device from the second device, a request for authentication data;
transmitting, by the mobile device to the second device, authentication data including the entered passcode; and
providing, by the second device, access to a secure area upon validation of the authentication data.

22. The system of claim 17, wherein executing a workflow includes:
transmitting, by the mobile device to the second device, authentication data including the entered passcode;
unlocking, by the second device, secure data stored on the second device upon validation of the authentication data; and
receiving, by the mobile device from the second device, the secure data.

23. The system of claim 17, wherein executing a workflow includes:
transmitting, by the mobile device to the second device, authentication data including the entered passcode;
exchanging, between the mobile device and the second device, shared content upon validation of the authentication data.

24. The system of claim 17, wherein executing a workflow includes:
broadcasting, by the mobile device, a connection request including the entered passcode;
detecting, by the mobile device, additional devices in proximity to the mobile device by receiving responses to the connection request; and
establishing communication links between the mobile device and one or more of the additional devices upon validation of the authentication data.

25. The system of claim 17, wherein executing a workflow includes:
enabling, by the mobile device, access to an application installed on the mobile device upon validation of the entered passcode.

26. The system of claim 17, wherein executing a workflow includes:
automatically transmitting, by the mobile device, a message upon validation of the entered passcode.

27. The system of claim 17, wherein executing a workflow includes:
transmitting, by the mobile device, a request for content to a server; and
receiving, by the mobile device, the requested content from the server.

28. The system of claim 27, wherein the requested content includes audio content, video content, web browser content, or any combination thereof.

29. The system of claim 17, wherein executing a workflow includes:
reading, by the mobile device, a barcode based on instructions received from the second device.

30. The system of claim 17, wherein executing a workflow includes:
transmitting, by the mobile device to the second device, authentication data including the entered passcode and payment processing data;
executing, by the second device, a purchase transaction based on the payment processing data and upon validation of the authentication data; and
receiving, by the mobile device from the second device, confirmation of the executed purchase transaction.

31. The system of claim 17, wherein activating a short-range frequency interface includes:
detecting, by the mobile device, a short-range frequency card in proximity to the mobile device;
reading, by the mobile device, data from the short-range frequency card; and
maintaining, by the mobile device, activation of the short-range frequency interface upon validation of the data read from the short-range frequency card.

32. The system of claim 17, wherein the short-range frequency interface on the mobile device includes a card emulator configured to enable the mobile device to communicate with a card reader device.

33. A computer program product, tangibly embodied in a non-transitory computer-readable storage device, for providing secure execution of mobile device workflows, the computer program product including instructions operable to cause a mobile device to:
receive a request to launch a function on the mobile device;
display a keypad associated with the launched function, the keypad having randomly-arranged alphanumeric characters;
receive entry of a passcode via the keypad;
activate a short-range frequency interface on the mobile device upon validation of the entered passcode;
establish a communication link with a second device using the short-range frequency interface; and
execute a workflow based on data transmitted between the mobile device and the second device via the communication link.
